(19) United States
(12) Patent Application Publication
(10) Pub. No.: US 2007/0097272 A1
(43) Pub. Date: May 3, 2007

(54) Delay-less Channel Switching

(75) Inventors: Mohammad R. Moradi, Sunnyvale, CA (US); Yu-Wen (Evan) Chang, Fremont, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: MediaPhy Corporation, San Jose, CA (US)

(21) Appl. No.: 11/554,981

(22) Filed: Oct. 31, 2006

Related U.S. Application Data
(60) Provisional application No. 60/732,020, filed on Oct. 31, 2005.

(51) Int. Cl. H04N 5/50

(52) U.S. Cl. 348/731

(57) ABSTRACT

A method for enabling delay-less switching of TV channels in a mobile device is as follows. Memory space is allocated in a buffer memory to each of a user's favorite TV channels. Each allocated memory space is updated with a corresponding burst of newly received data. In response to a command indicating selection of a new favorite TV channel, a sufficient amount of data is retrieved from the memory space allocated to the newly selected favorite TV channel to ensure that the user experiences substantially minimal delay in changing to the new favorite TV channel.

### CROSS-REFERENCES TO RELATED APPLICATIONS

This application claims the benefit of U.S. Provisional Application No. 60/732,020, filed Oct. 31, 2005, which is incorporated herein by reference in its entirety for all purposes.

### BACKGROUND OF THE INVENTION

The present invention relates in general to mobile digital TV (MDTV) technology, and more particularly to a delay-less channel switching technique which enables a user of an MDTV to switch TV channels without experiencing any visible delay. The technique of the present invention may be implemented in any MDTV including mobile phone, PDA's, iPODs, iPACs, portable video players, portable multimedia players, portable DVD players, lap-top PCs, TVs in transportation means (including cars, buses, and trains), portable game consoles, and digital still cameras and video camcorders.

The digital video broadcast (DVB) standards that are either in effect or are at various stages of development include the European standard DVB-H, the Japanese standard ISDB-T, the Korean standards digital audio broadcasting (DAB)-based Terrestrial-DMB and Satellite-DMB, the Chinese standards DTV-M, Terrestrial-Mobile Multimedia Broadcasting (T-MMB), and Satellite and terrestrial interaction multimedia (STiMi), and the MediaFLO format proposed by Qualcomm Inc. While the present invention is described in the context of the DVB-H standard, it may also be implemented in any of the above or future standards, and as such is not limited to any one particular standard.

The DVB-H standard (digital video broadcasting for handheld devices) was developed and optimized for digital TV reception on battery-based mobile devices, which may move at high velocities. Present time DVB transmitter systems are capable of sending a channel with bandwidth in the range of 5-8 MHz. A DVB transmitter system broadcasts the contents with a bit rate of about 5 Mbps or higher. A transmission channel is capable of carrying multiple TV stations. The number of TV stations in a transmission channel depends upon the type of modulation and the bandwidth of the transmission channel.

The signal which is presented to the DVB-H receiver contains multiple time-sliced bursts of TV channels. The utilization of this time-division-multiplexing (TDM) scheme reduces the overall average power consumption in a receiver. To capture the data for a specific TV channel, the receiver is active for a short duration that is needed for channel acquisition and capturing of the actual data. Once the data is captured, part of the receiver will be shutdown for power saving purposes.

FIGS. 1A and 1B depict two methods that can be employed by broadcasters for transmitting video and data. In the FIG. 1A method, data for each TV channel is transmitted in one big time slice in each period (e.g., of 4 seconds), while each TV channel in the FIG. 1B method is transmitted in one small time slice in a short time period (e.g., 100s of milliseconds). A drawback of the transmission method in FIG. 1A is the delay (of up to four seconds) that the viewer experiences when changing a channel. While the FIG. 1B transmission method substantially minimizes this delay by transmitting mini time slices in shorter time periods, the FIG. 1B method suffers from excessive power consumption due the increased number of channel acquisitions as compared to the FIG. 1A method. Thus, there is a need for a technique which substantially minimizes the delay a viewer experiences when changing channels, while the power consumption is maintained at a minimum.

### BRIEF SUMMARY OF THE INVENTION

In accordance with an embodiment of the invention, a method for enabling delay-less switching of TV channels in a mobile device is as follows. Memory space is allocated in a buffer memory to each of a user's favorite TV channels. Each allocated memory space is updated with a corresponding burst of newly received data. In response to a command indicating selection of a new favorite TV channel, a sufficient amount of data is retrieved from the memory space allocated to the newly selected favorite TV channel to ensure that the user experiences substantially minimal delay in changing to the new favorite TV channel.

In one embodiment, each burst has a predetermined burst rate and a burst duration, and a burst period is defined as the period between two successive bursts of the same TV channel, and the amount of data retrieved from the memory space allocated to the newly selected favorite channel is determined using the predetermined burst rate and burst duration, the burst period and the amount of time elapsed from the most recent burst of the newly selected favorite channel to when the command is received.

In accordance with another embodiment of the invention, an apparatus configured to enable delay-less switching of TV channels in a mobile device includes a buffer memory and a fast-flip handler coupled to the buffer memory. The fast-flip handler is configured to allocate memory space within the buffer memory to each of a user's favorite TV channels, and to update each allocated memory space with a corresponding burst of newly received data, and the fast-flip handler is further configured so that when a new favorite TV channel is selected. The fast-flip handler is further configured to determine the amount of data that needs to be retrieved from the memory space allocated to the newly selected favorite TV channel to ensure that the user experience substantially minimal delay in changing to the new favorite TV channel.

In one embodiment, each burst has a predetermined burst rate and a burst duration, and a burst period is defined as the period between two successive bursts of the same TV channel, and the amount of data retrieved from the memory space allocated to the newly selected favorite channel is determined using the predetermined burst rate and burst duration, the burst period and the amount of time elapsed from the most recent burst of the newly selected favorite channel to when the command is received.

A better understanding of the nature and advantages of the present invention can be gained from the following detailed description and the accompanying drawings.

### BRIEF DESCRIPTION OF THE DRAWINGS

FIGS. 1A and IB depict two known methods that can be used by broadcasters for transmitting video and data;

FIG. 2 shows a simplified block diagram of a demodulator together with a buffer memory 210 for use in a DVB-H system, in accordance with an embodiment of the invention;

FIG. 3 shows the relation between the transport packet stream (TS) and the IP stream;

FIG. 4 shows those blocks of link layer 208 in FIG. 1 which enable delay-less channel switching, according to one embodiment of the invention;

FIG. 5 is an exemplary timing scenario used to show various timings and parameters used in equations (1)-(5) below;

FIG. 6 is a flow chart showing the series of operations that are carried out in achieving seamless channel transition, in correspondence with equations (1)-(5);

FIG. 7 is a flow chart used to describe the operations that take place when a user changes a channel;

FIG. 8 is a flow chart used to describe the operations that take place when the user adds or removes one or more favorite channels;

FIG. 9 illustrates the embodiment wherein the buffer memory resides outside the demodulator;

FIG. 10 shows the embodiment wherein buffer memory 1006 is integrated monolithically on the same silicon;

FIG. 11 shows an embodiment of the invention where the delay-less feature and video recording capability are provided in the same mobile device; and

FIG. 12 shows a representation of an exemplary memory for mobile video recording.

### DETAILED DESCRIPTION OF THE INVENTION

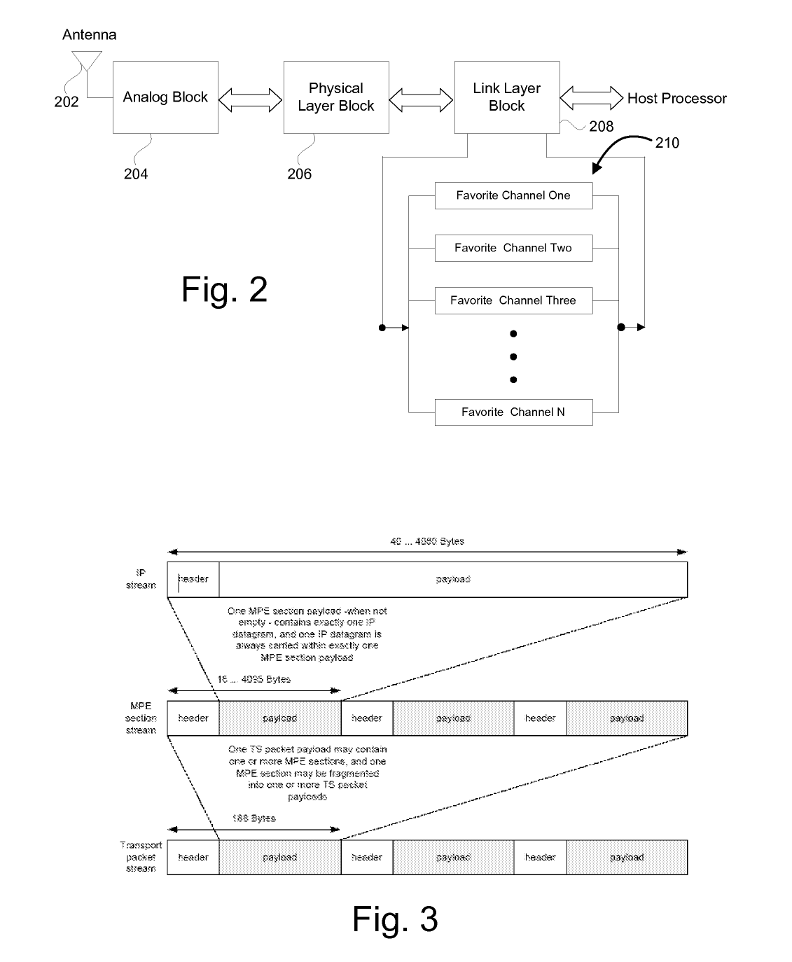

FIG. 2 shows a simplified block diagram of a demodulator together with a buffer memory 210 for use in a DVB-H system, in accordance with an embodiment of the invention. In FIG. 2, the demodulator receives the broadcasted RF signal (e.g., of the L-band (1.4-1.7 GHz), UHF band (450-800 GHz) and VHF band (170-240 MHz)) via an antenna 202. An analog block 204 converts the RF signal into Baseband. Physical layer block 206 then performs demodulation to convert the Baseband signal into digital bit streams. Link layer block 208 parses the digital bit streams into tables and video bit streams. The demodulated, selected channel stream is then outputted in the format of either MPEG transport packets or IP datagrams. The demodulated data is then decoded (e.g., using an MPEG decoder such as MPEG4/H.264 decoder), and is then further processed for display on the mobile device screen. The decoder may be integrated into the host processor or may be a stand alone block that communicates with the host processor. The demodulator also includes a CPU (not shown) that communicates with other blocks in the demodulator as well as the host processor through an internal bus. FIG. 3 shows the relation between the transport packet stream (TS) and the IP stream. The TS packets of a specific TV channel (with the size of 188 bytes and the rate specific to the transmission channel bandwidth and modulation type) flow from physical layer block 206 to link layer block 204.

Link layer block 208 communicates with buffer memory 210 and allocates a memory space of up to 2 Mb to each TV channel designated by the user of the MDTV as user's favorite channel. An entire burst of each favorite TV channel is stored in the corresponding 2 Mb of memory space. The buffer memory can be implemented using one or more volatile storage devices (e.g., SRAM or DRAM) or one or more non-volatile storage devices (e.g., flash or EEPROM) or a combination of both depending on the desired size and performance characteristics of the memory. The amount of buffer memory needed depends on the number of desired favorite channels. In one embodiment wherein a maximum of 1.5 Mbits is allocated to each burst of time-sliced TV channel, the required memory density can be calculated by multiplying the number of favorite channels to 1.5 MBits. The minimum required speed of the buffer memory can also be calculated in part from the required drain rate of the buffer memory.

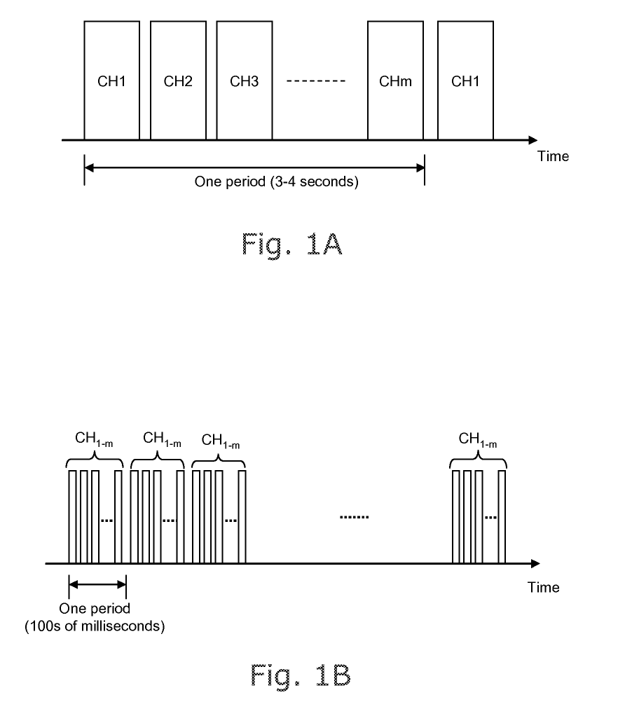

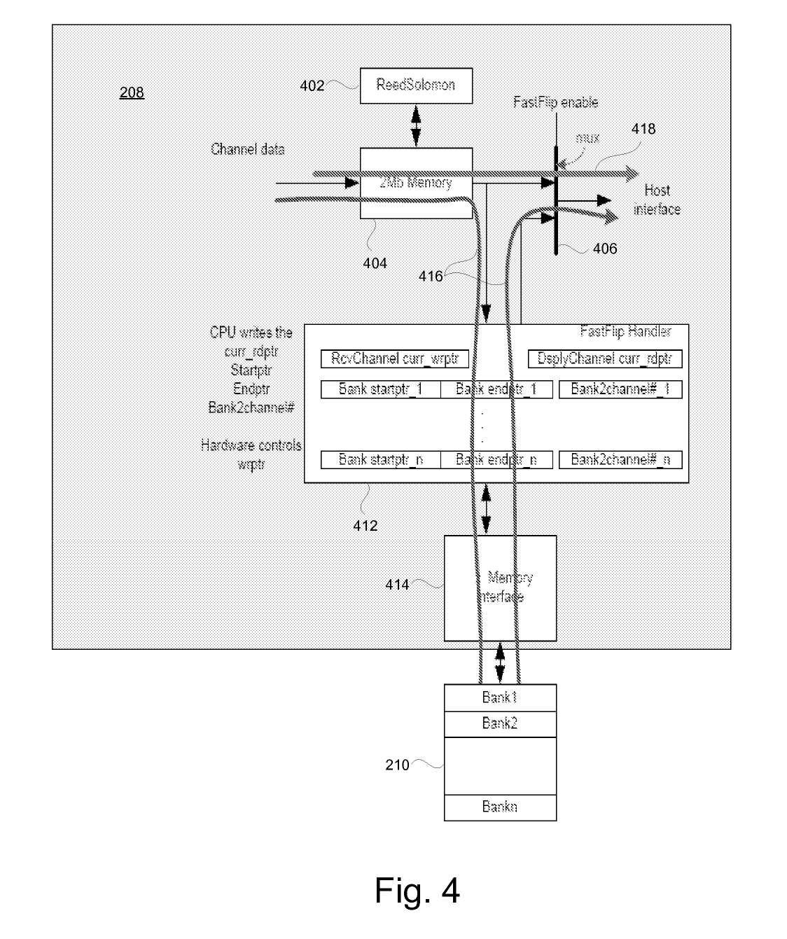

FIG. 4 shows those blocks of link layer 208 in FIG. 1 which enable delay-less channel switching, according to one embodiment of the invention. Link layer block 208 controls the issuance of a command to physical layer block 206 to capture the data for all the designated favorite TV channels. In FIG. 4, frame memory 404 together with Reed Solomon block 402 store and perform error correction on incoming successive bursts of time sliced TV channels. Depending on the designated favorite channels, the corresponding error-corrected bursts are redirected to buffer memory 210 through fast-flip handler block 412 and memory interface block 414. The bursts of time-sliced TV channels stored in buffer memory 210 are updated every new corresponding burst. In this manner the most recent data for each time-sliced channel is readily available in buffer memory 210 at any given time. As will be described in more detail below, when the user switches to a new favorite channel, all or a portion of the most recent burst of the newly selected TV channel is retrieved from buffer memory 210 and supplied to the host processor through multiplexer 406.

If the user selects a TV channel that is not among the designated favorite channels, corresponding bursts of the newly selected time-sliced TV channel are fed directly through multiplexer 406 without first being stored in buffer memory 210. In this case the user may experience a delay of up to, for example, 4 seconds. The fast-flip handler block 412 facilitates the delay-less channel switching as described next.

The CPU in the demodulator uses hardware registers (few of which are shown in fast-flip handler 412) to manipulate the buffer memory pointers in order to properly manage the flow of video data into and out of buffer memory 210. For ‘n’ favorite channels, ‘n’ banks of memory (Bank1 through Bankn) are allocated, one for each favorite channel. Two pointers are used to identify the beginning and end of each allocated bank. For example, bank-start-pointer “Bank startptr_1” and bank-end-pointer “Bank endptr_1” identify the beginning and the end of bank 1. A total of “n” registers store the bank-to-channel mapping information. For example, the register storing the value Bank2channel#_1 identifies the bank allocated to channel 1. The current (favorite channel) receiving-channel-write-pointer (RcvChannel curr_wrptr) indicates where in the bank corresponding to the current favorite channel the incoming data is to be written. And the current display-channel-read-pointer (DisplyChannel curr_rdptr) indicates where in bank corresponding to the current channel to be displayed is the data to be read from.

The CPU in the demodulator handles the programming of the bank-start-pointer, bank-end-pointer and bank2channel# registers as part of the setup when the user adds or removes one or more new channels. Logic in the fast-flip handler 412 manages the RcvChannel curr_wrptr and DsplyChannel curr_rdptr pointers. However, when the channel is changed to a new favorite channel, CPU can write into the DsplyChannel curr_rdptr to force the fast-flip handler 412 to identify the appropriate bank and start retrieving data from an appropriate location within the bank. The formulas for identifying the appropriate bank and the appropriate amount of data to be retrieved from the bank are described in detail further below. Thus, when the user switches to a new channel, the host processor communicates the change of channels to the CPU in the demodulator, and the CPU then calculates the new DsplyChannel curr_rdptr value according to the equations described next, and forces the value into the DsplyChannel curr_rdptr register. This results in retrieval of sufficient amount of video data from the bank corresponding to the newly selected favorite channel, so that the user experiences minimal to no visible delay in changing the channel.

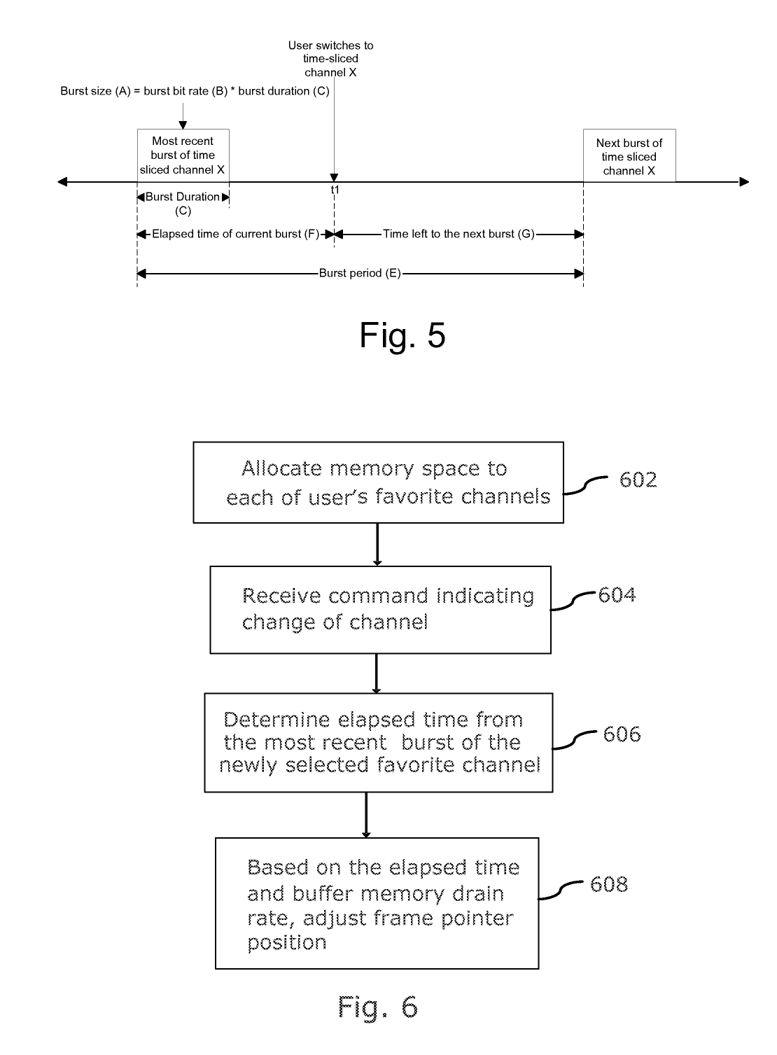

When changing to a new favorite time-sliced channel, the starting byte position within buffer memory 210 allocated to the new favorite time-sliced channel is calculated based on the equations below to ensure seamless channel transition. The example in FIG. 5 will be used in conjunction with the equations below to illustrate the seamless channel transition. The FIG. 5 example corresponds to the scenario where the user switches from one time-sliced channel to a new favorite time-sliced channel X at time t1. FIG. 5 also shows the most recent burst and the next burst of time-sliced channel X as well as various parameters appearing in the equations below. As indicated in FIG. 5, the Burst size (A) is determined by equation (1):
Burst size A(Bits)=Burst bit rate B(Bits/Sec)*Burst duration C(Sec) (1)

The rate at which the memory space (within buffer memory 210) allocated to time-sliced channel X is drained is determined by equation (2):
Drain rate D(Bits/Sec)=Burst size A(Bits)/Burst period E(Sec) (2)

The time elapsed from the beginning of the most recent burst of the time-sliced channel X to time t1 when the user switches to the time-sliced channel X is determine by equation (3):
Elapsed time F(Sec)=Burst Period E(Sec)−Time remaining to next burst G(Sec) (3)

The bit pointer position for the buffer allocated to time-sliced channel X is determined by equation (4):
Bit pointer position H(Bits)=Drain rate D(Bits/Sec)*Elapsed time F(Sec) (4)

And finally, the position of the byte of data (in the most recent burst of time sliced channel X) to be processed in order to ensure seamless channel transition is determined by equation (5):
Byte buffer position J(Byte)=Bit pointer position H(Bits)/8(Bits/Byte) (5)

The above equations may be implemented in software or hardware. The technique embodied by equations (1)-(5) ensures seamless transition from one channel to another for any give burst bit rate B, burst duration C, and burst period E, and as such is not limited to those shown in FIGS. 1A and 1B. The flow chart in FIG. 6 sets forth the series of operations that are carried out in achieving seamless channel transition, in correspondence with equations (1)-(5). In step 602, a memory space in buffer memory 210 is allocated to each of the user's favorite channels, each allocated buffer memory space being configured to store the most recently received burst of the corresponding time-sliced channel. In step 604, a command indicating change of channel is received from the user. In step 606, the time elapsed from the beginning of the most recent burst of the newly selected time-sliced channel to when the command is received from the user is determined. In step 608, using the elapsed time and the drain rate of the buffer memory, the position of the frame pointer is adjusted to point to a location in the buffer memory such that upon processing of the buffer memory data portion corresponding to the adjusted pointer location, a seamless transition from the previous channel to the newly selected favorite channel is obtained. This algorithm, in effect, results in identifying and processing a sufficient amount of data from the most recent burst of the newly selected time-sliced channel to fill the time gap between when the user switches to the new channel and the next burst of the newly selected channel, thereby ensuring that the user does not experience any idle time in switching to the new favorite channel.

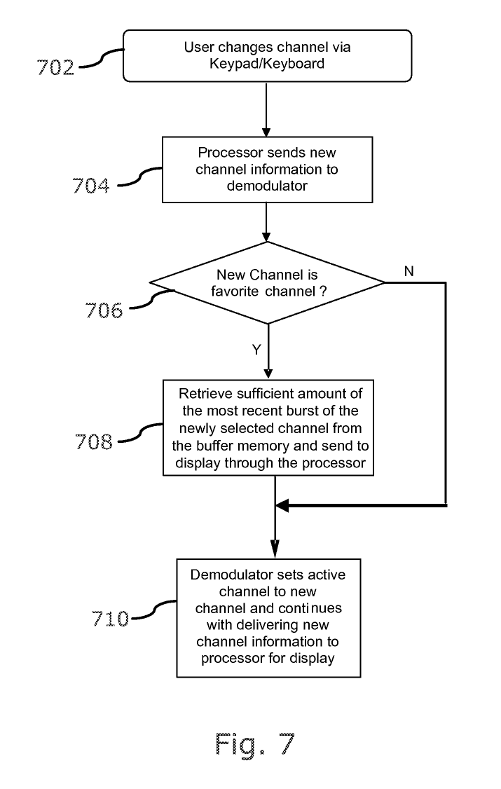

The flow chart in FIG. 7 will be used to describe the operations that take place when a user changes a channel. In step 702, the user changes the viewing channel via the keypad (e.g., on a hand-held devices) or keyboard (e.g., on a laptop computer). In step 704 the host processor sends new channel information to the CPU in the demodulator for processing. In step 706 the new channel information is compared with the previously designated favorite channels. If a match is found (i.e., the newly selected channel is a favorite channel), the link layer retrieves a sufficient amount of the most recent burst of the newly selected channel from the buffer memory and sends to the processor for displaying on the display. If a match is not found (i.e., the new channel is not a favorite channel), the buffer memory is not accessed. In step 710, the demodulator sets active channel to the new channel and continues with processing and delivering new channel information to the processor for display.

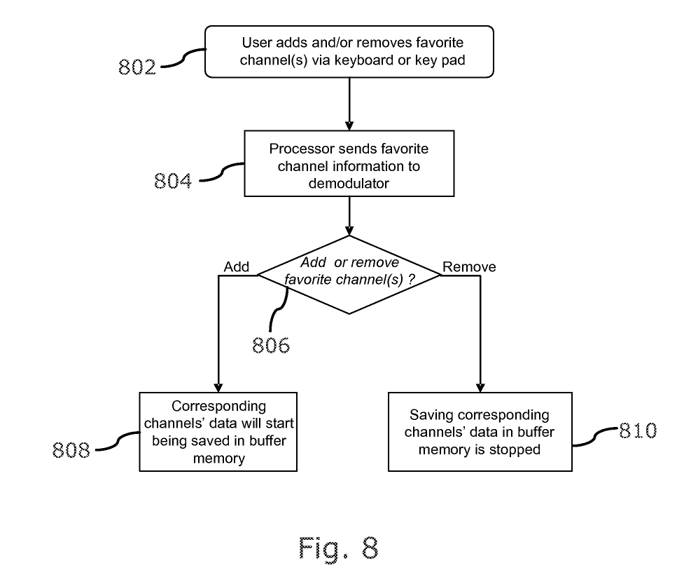

The flow chart in FIG. 8 will be used to describe the operations that take place when the user adds or removes favorite channels. In step 802, the user adds and/or removes one or more favorite channels via the keyboard or keypad. In step 804, the host processor sends the favorite channel information input by the user to the CPU in the demodulator for further processing. In step 806, depending on whether favorite channel(s) are added or removed, one or both operations depicted by steps 808 and 810 takes place. Step 808 corresponds to the case where one or more favorite channels are added. In this case, bursts of corresponding channels start being saved in buffer memory. Step 810 corresponds to the case where one or more favorite channels are removed. In this case, the link layer stops saving corresponding channels in the buffer memory.

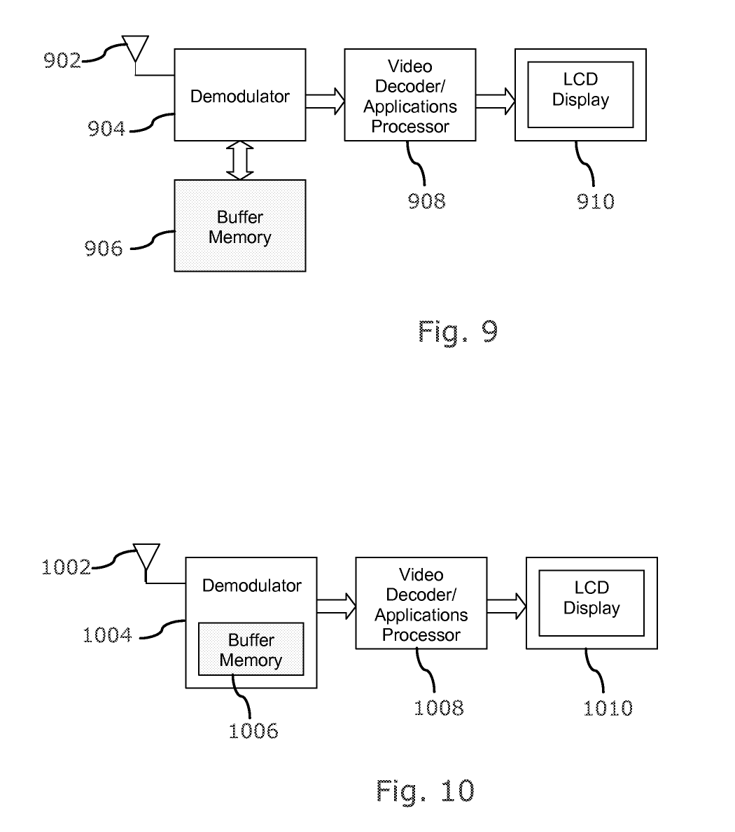

The buffer memory may be formed on-chip of off-chip. FIG. 9 also illustrates a few of the components that are present in a mobile digital TV. Antenna 902 is coupled to demodulator 904, and demodulator 904 exchanges favorite channel data with buffer memory 906. Demodulator 904 sends the demodulated video data to the video decoder/application processor block 908, and processor block 908 in turn process the video data and displays it on the display 910. Note that while the arrows indicate data flow from demodulator 904 to processor 908, processor does send commands and information (e.g., favorite channel information) to demodulator 904. FIG. 10 shows the embodiment wherein buffer memory 1006 is integrated monolithically on the same silicon. Each of these two embodiments has advantages and disadvantages that make them suitable for various applications.

Referring back to FIG. 4, multiplexer 406 provides the flexibility to the mobile device manufacturers to enable or disable the delay-less feature. The FastFlip enable signal is a control signal which selects one of the two data paths marked by reference numerals 416 and 418. The upper arrow marked by reference numeral 418 shows the data path for the case where the delay-less feature is disabled, while the lower arrow marked by reference numeral 416 shows the data path for the case where the delay-less feature is enabled. In another embodiment, the selection between these two paths is made automatically. That is, if the demodulator detects the presence of an external buffer memory on the external bus, then multiplexer 406 enables the delay-less feature by selecting the lower data path. If no external buffer memory is detected on the bus, then the upper path is selected.

While the FIG. 4 embodiment shows that error correction is carried out on each incoming burst of time sliced TV channel, in one embodiment error correction is carried out only under limited circumstances. For example, since physical layer 206 performs error correction on the incoming data, link layer can check the physical layer (e.g., its error counters) to determine if further error correction may be necessary.

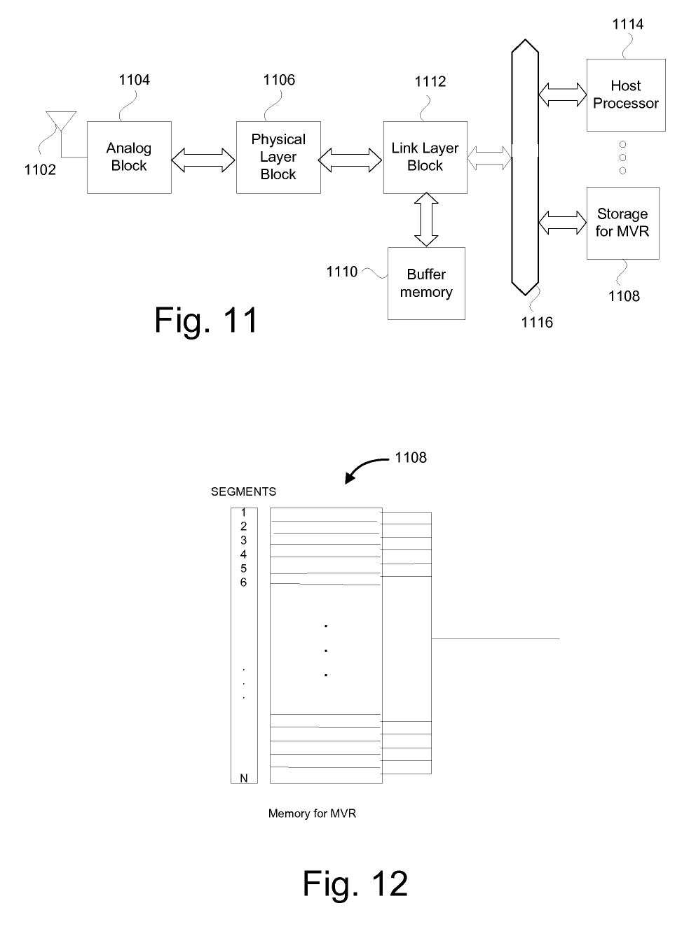

FIG. 11 shows an embodiment of the invention where both the delay-less feature and video recording capability are provided in the same mobile device. FIG. 11 is similar to FIG. 2 except that a separate storage block 1108 (identified in FIG. 11 as “Storage for MVR” (mobile video recorder)) is provided for recording TV programs. This enables the user to watch one TV program while recording one or more other TV programs. As can be seen, link layer block 1112 communicates with external host processor 1114 and storage block 1108, as well as other external resources, via external bus 1116. Thus, incoming video data associated with a TV channel that carries the desired program is demodulated and then stored in storage block 1108 via bus 1116. Once the recording is complete, storage memory 1108 can be directly accessed for viewing the recorded program without using the demodulator.

FIG. 12 shows one exemplary representation of storage block 1108 for mobile video recording (MVR), which is divided into multiple segments with each segment representing one block of memory. Each block is allocated to one TV channel, and in one embodiment, the size of each block is programmable depending on the length of a video program. Depending on the size of the MVR memory, the user can allocate multiple segments to store multiple channels at the same time. The data for a given channel is stored contiguously in storage block 1108. A frame pointer position starts from the beginning of memory 1108 and advances to the next empty location. Any new data for the channel is appended to the end of the last data. This process continues till the entire memory is full. Once the last location of the memory is reached, the pointer will wrap around to the first location of the storage device. Alternatively, when the memory becomes full, the user is prompted to make additional memory space available so that recording can continue. In yet another embodiment, when the user selects a TV program for recording, the memory is checked for available memory space, and if sufficient memory space is not available for the selected program, the user is prompted to make additional memory space available. Storage block 1108 needs to be non-volatile (e.g., flash, EEPROM or NOVRAM or hard disc drive) so that when the power to the mobile device is turned off, previously recorded TV programs are preserved. Similar to buffer memory 1110, storage block 1108 may also be monolithically integrated on the same integrated circuit as the demodulator.

The above techniques of the present invention may be implemented in any mobile device TV including mobile phones, PDAs, iPODs, iPACs, portable video players, portable multimedia players, portable DVD players, lap-top PCs, TVs in transportation means (including cars, buses, and trains), portable game consoles, and digital still and video camcorders. Further, the above techniques are not limited to any particular digital video broadcasting standard, and may be implemented in any of the presently known or future standards.

It is to be understood that the term “delay-less” and other similar terms used herein are not to be construed in a limiting fashion, as there is a finite amount of time delay from when a user changes a channel to when images of the new channel start being displayed on the screen of the mobile device. However, in accordance with the invention, this finite amount of delay is substantially minimized such that the user experiences minimal to no delay in viewing the newly selected channel.

While the present invention has been particularly shown and described with reference to exemplary embodiments thereof, it will be understood by those of ordinary skill in the art that various changes in form and details may be made therein without departing from the spirit and scope of the present invention as defined by the claims.

What is claimed is:

1. A method for processing data in a mobile device with television viewing capability, comprising:
allocating memory space in a buffer memory to each of a user's favorite TV channels;
updating each allocated memory space with a newly received burst of data of a corresponding favorite channel; and
in response to a command indicating selection of a new favorite TV channel, retrieving a sufficient amount of data from the memory space allocated to the newly selected favorite TV channel to ensure that the user experiences substantially minimal delay in changing to the new favorite TV channel.

2. The method of claim 1 wherein the retrieving a sufficient amount of data comprises:
determining the amount of time elapsed from the most recent burst of the newly selected favorite channel to when the command is received.

3. The method of claim 1 wherein:
each burst has a predetermined burst rate and a burst duration, and a burst period is defined as the period between two successive bursts of the same TV channel, and
the amount of data retrieved from the memory space allocated to the newly selected favorite channel is determined using the predetermined burst rate and burst duration, the burst period and the amount of time elapsed from the most recent burst of the newly selected favorite channel to when the command is received.

4. An apparatus configured to process data in a mobile device with television viewing capability, comprising:
a buffer memory; and
a fast-flip handler coupled to the buffer memory, and configured to allocate memory space within the buffer memory to each of a user's favorite TV channels, and to update each allocated memory space with a corresponding burst of newly received data, and the fast-flip handler is further configured so that when a new favorite TV channel is selected, the fast-flip handler determines the amount of data that needs to be retrieved from the memory space allocated to the newly selected favorite TV channel to ensure that the user experience substantially minimal delay in changing to the new favorite TV channel.

5. The apparatus of claim 4 wherein:
each burst has a predetermined burst rate and a burst duration, and a burst period is defined as the period between two successive bursts of the same TV channel, and
the amount of data retrieved from the memory space allocated to the newly selected favorite channel is determined using the predetermined burst rate and burst duration, the burst period and the amount of time elapsed from the most recent burst of the newly selected favorite channel to when the command is received.

6. A method for processing data in a mobile device with television viewing capability, comprising:
wirelessly receiving periodic bursts of data for a predetermined number of TV channels;
storing newly received burst of data of each of a user-defined one or more TV channels, the user-defined one or more TV corresponding to one or more of the predetermined number of TV channels; and
in response to selection for viewing of one of the user-selected one or more channels, retrieving a sufficient amount of the data from the most recently stored burst of data corresponding to the newly selected channel to ensure that the user experiences substantially minimal delay in viewing the newly selected channel.
